(19) United States
(12) Patent Application Publication
(10) Pub. No.: US 2026/0359213 A1
(43) Pub. Date: Nov. 12, 2026

(54) SECURE ALLOCATION OF VOLATILE MEMORY FOR SMART CARD APPLICATION DESIGN IN EMBEDDED SYSTEMS

(71) Applicant: VISA INTERNATIONAL SERVICE ASSOCIATION, San Francisco, CA (US)

(72) Inventors: YUEXI CHEN, Foster City, CA (US); Kiat TAN, Singapore (SG); Baoxiang KANG, Singapore (SG); Prasanna HEGDE, Singapore (SG)

(73) Assignee: VISA INTERNATIONAL SERVICE ASSOCIATION, San Francisco, CA (US)

(21) Appl. No.: 19/487,029

(22) PCT Filed: May 25, 2023
(86) PCT No.: PCT/US2023/023540

§ 371 Date: Nov. 24, 2025

(51) Int. Cl. G06F 12/02; G06F 8/61; G06Q 20/34

(52) U.S. Cl. CPC G06F 12/0238; G06F 8/61; G06Q 20/341

(57) ABSTRACT

In some embodiments, a computer-implemented method includes receiving a smart card applet for program execution on a smart card; determining whether a memory allocation type keyword provided via the smart card applet is of a transient memory allocation type; and when the memory allocation type keyword is of the transient memory allocation type, allocating volatile memory from the smart card for temporary storage of an object entity. In some embodiments of the computer-implemented method, the transient allocation type keyword is utilized to indicate whether the memory allocation type keyword is the transient memory allocation type.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Smart cards are utilized by many consumers to perform various financial transactions. The memory available on smart cards to execute and store smart card applications is restricted due to the limited amount space available for memory on the smart cards. As a result, smart card application engineers often encounter design issues in designing the smart card applications using an object-oriented design. For example, memory constraints related to the storage of objects on the memory of smart cards often hinder the design of the smart applications. Therefore, a need exists to develop techniques for the design of smart applications that account for the memory constraints on smart cards.

### BRIEF DESCRIPTION OF THE DRAWINGS

FIG. 1 illustrates a block diagram of a smart card in accordance with some embodiments.

FIG. 2 illustrates a block diagram of an object entity volatile memory allocation system included in non-volatile memory that is utilized to allocate volatile memory in the smart card of FIG. 1 in accordance with some embodiments.

FIG. 3 is a flow diagram illustrating an object reference volatile memory allocation method in accordance with some embodiments.

FIG. 4 is a flow diagram illustrating an object volatile memory allocation method in accordance with some embodiments.

### DETAILED DESCRIPTION

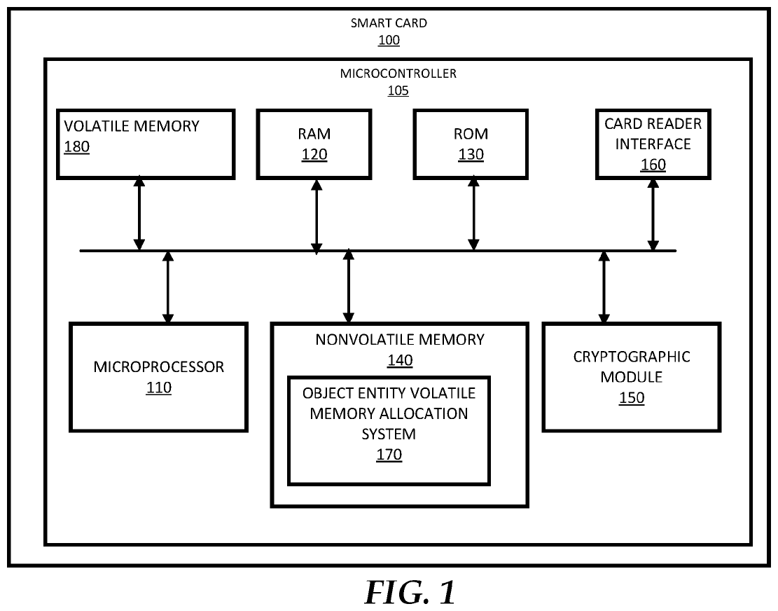

FIG. 1 illustrates a block diagram of a smart card 100 in accordance with some embodiments. In some embodiments, smart card 100 includes an embedded microcontroller 105 that includes a microprocessor 110, random access memory (RAM) 120, read-only memory (ROM) 130, non-volatile memory 140, a cryptographic module 150, a card reader interface 160, and volatile memory 180. In some embodiments, smart card 100 is configured to utilize an object entity volatile memory allocation system 170 to allocate volatile memory of volatile memory 180 to object entities utilized in the execution of smart card applets on smart card 100. In some embodiments, an object entity may be, for example, an object and/or an object reference generated using an object-oriented programming language, such as, Java or other high-level object-oriented programming language. In some embodiments, an object reference refers to a variable that holds a reference to an instance of an object, where an object is an instance of a class. In some embodiments, in order to allocate volatile memory of volatile memory 180 for an object entity, the object entity volatile memory allocation system 170 (executed by microcontroller 110) is configured to utilize a volatile memory allocation type keyword defined in a smart card applet installed on the smart card 100 to allocate the volatile memory for the object entity (e.g., the object and/or the object reference). In some embodiments, use of the object entity volatile memory allocation system 170 allows smart card applets installed on smart card 100, such as, Java applets, that traditionally do not have access to volatile memory for storing object entities, to access volatile memory for storage and execution during runtime, as described further herein with reference to FIG. 1-FIG. 4.

In some embodiments, with further reference to FIG. 1, microprocessor 110 is any suitable central processing unit for executing commands and controlling smart card 100. In some embodiments, RAM 120 serves as storage for calculated results and as stack memory. In some embodiments, ROM 130 stores the operating system, fixed data, standard routines, and look up tables. In some embodiments, RAM 120 may serve as volatile memory 180 or vice versa.

In some embodiments, cryptographic module 150 is an optional hardware module used for performing a variety of cryptographic algorithms. Card reader interface 160 includes the software and hardware necessary for communication with the outside world. A wide variety of interfaces are possible. By way of example, card reader interface 160 may provide a contact interface, a close-coupled interface, a remote-coupled interface, or a variety of other interfaces. With a contact interface, signals from the microcontroller are routed to a number of metal contacts on the outside of the card which come in physical contact with similar contacts of a card reader device.

In some embodiments, non-volatile memory 140 includes object entity volatile memory allocation system 170. In some embodiments, the object entity volatile memory allocation system 170 is executable code configured to allocate volatile memory of volatile memory 180 to object entities utilized in the execution of smart card applets on smart card 100. In some embodiments, the non-volatile memory may be, for example, EPROM or EEPROM that serves to store information that must not be lost when the smart card 100 is disconnected from a power source but that must also be alterable to accommodate data specific to the individual smart card or any changes possible over the lifetime of the smart card. In some embodiments, additional information stored on non-volatile memory 140 may include, for example, a card identification number, a person al identification number, authorization levels, cash balances, credit limits, etc., or other information related to financial transactions associated with the smart card 100.

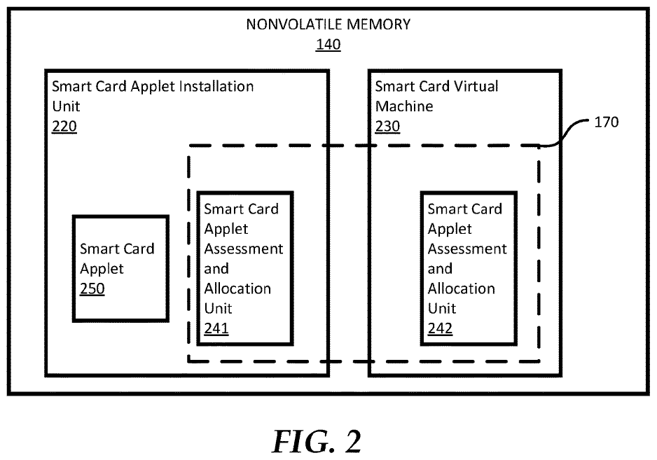

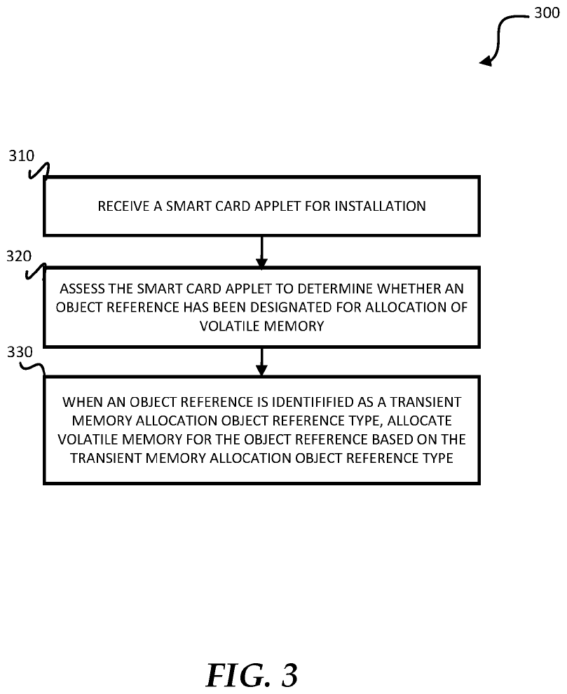

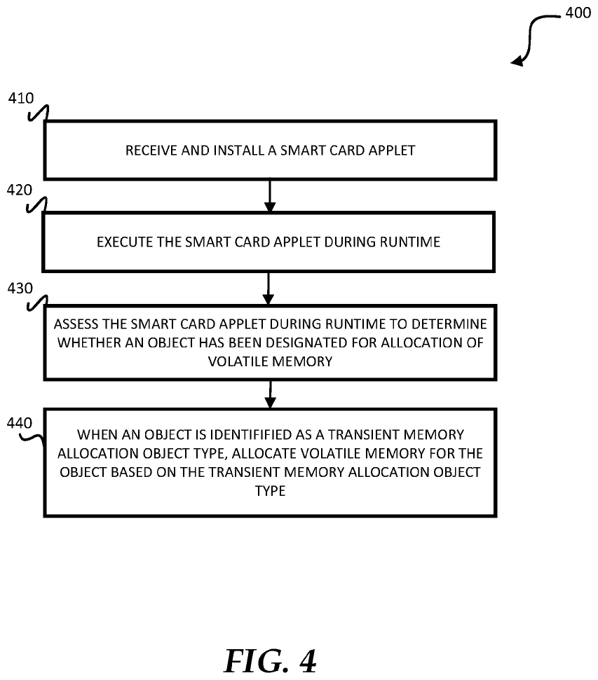

FIG. 2 illustrates a block diagram of object entity volatile memory allocation system 170 in accordance with some embodiments. In some embodiments, as stated previously, object entity volatile memory allocation system 170 is executable code configured to allocate volatile memory of volatile memory 180 for object entities utilized in the execution of a smart card applet 250 on smart card 100. In some embodiments, as stated previously, an object entity may be, for example, an object and/or an object reference generated using an object-oriented programming language, such as, Java or other high-level object-oriented programming language utilized to generate a smart card applet or application for smart card 100. In some embodiments, smart card applet 250 is an object-oriented programming smart card applet that, in addition to being configured to execute on smart card 100, is configured to define transient memory allocation object entity code (e.g., transient memory allocation object code and/or transient memory allocation object reference code) that is utilized by the object entity volatile memory allocation system 170 to allocate volatile memory of volatile memory 180. In some embodiments, the object entity volatile memory allocation system 170 utilizes an object reference volatile memory allocation method 300 (described further herein with reference to FIG. 3) and/or an object volatile memory allocation method 400 (described further herein with reference to FIG. 4) to allocate volatile memory of volatile memory 180 for the object entities.

### Volatile Memory Allocation for Object References During Installation of the Smart Card Applet 250 on Smart Card 100

In some embodiments, the object entity volatile memory allocation system 170 includes a smart card applet assessment and allocation unit 241 of smart card applet installation unit 220 and a smart card applet assessment and allocation unit 242 of smart card virtual machine (SCVM) 230. In some embodiments, the smart card applet installation unit 220 is executable code that, in addition to being configured to perform tasks associated with installing the smart card applet 250 onto the smart card 100, is configured to utilize the smart card applet assessment and allocation unit 241 to perform a transient memory allocation object reference code assessment of smart card applet 250 in order to allocate the volatile memory of volatile memory 180 for an object reference defined in the smart card applet 250. In some embodiments, the transient memory allocation object reference code assessment is an assessment of the smart card applet 250 performed by the smart card applet assessment and allocation unit 241 for transient memory allocation object reference code, where the transient memory allocation object reference code is executable code in smart card applet 250 indicative of allocating volatile memory of volatile memory 180 for the object reference defined in the smart card applet 250. In some embodiments, transient memory allocation object reference code is defined in the smart card applet 250 and includes a volatile memory allocation object reference type keyword. In some embodiments, the volatile memory allocation object reference type keyword is a keyword in the smart card applet 250 indicative of allocating volatile memory of volatile memory 180 for storage of the object reference in volatile memory 180. In some embodiments, the volatile memory allocation object reference type keyword may be a transient memory allocation object reference type keyword, such as, for example, the keyword “transient” located prior to the object reference (e.g., public transient MyClass objectRef in the volatile memory allocation object reference example illustrated using Java code below). In some embodiments, a volatile memory allocation object reference example that utilizes a transient memory allocation object reference type keyword to allocate volatile memory from volatile memory 180 is exemplified utilizing object-oriented programming in the Java code below:

```
    public class Example {
          /*** Example of Utilizing Transient Memory Allocation Object Reference Type
Keyword to Allocate Volatile Memory 180 for an Object Reference */
          public transient MyClass objectRef;
          public void setObjectRef(MyClass oRef){
          /*** Example of Writing into objectRef on Volatile Memory of Volatile Memory
180 Resolves Programming Constraints */
                objectRef = oRef;
          }
    }
```

In some embodiments, in the volatile memory allocation object reference example above, the executable code in smart card applet 250 defines an object reference (e.g., objectRef) as being allocated to volatile memory of volatile memory 180. As a result, during installation of the smart card applet 250 by smart card applet installation unit 220, the smart card applet assessment and allocation unit 241 allocates volatile memory of volatile memory 180 for the object reference as defined utilizing the volatile memory allocation object reference type keyword. Similar to the allocation of volatile memory of volatile memory 180 for an object reference using smart card applet assessment and allocation unit 241 being described herein, the allocation of volatile memory of volatile memory 180 for an object (or object instance) utilizing smart card applet assessment and allocation unit 242 during runtime is also described herein.

### Volatile Memory Allocation for an Object During Smart Card Runtime

In some embodiments, in order to allocate volatile memory of volatile memory 180 for an object during runtime of the smart card 100, object entity volatile memory allocation system 170 utilizes the smart card applet assessment and allocation unit 242 of SCVM 230. In some embodiments, the SCVM 230 is executable code that, in addition to being configured to perform traditional smart card virtual machine tasks (e.g., interpreting and executing bytecode instructions, managing memory and resources, and providing the necessary runtime environment for smart card applets), is configured to utilize the smart card applet assessment and allocation unit 242 to perform a transient memory allocation object code assessment of smart card applet 250 and allocate volatile memory of volatile memory 180 for an object defined in the smart card applet 250 based on the transient memory allocation object code assessment. In some embodiments, the transient memory allocation object code assessment is an assessment of the smart card applet 250 for transient memory allocation object code, where the transient memory allocation object code is executable code in smart card applet 250 indicative of allocating volatile memory of volatile memory 180 for the object defined in a smart card applet 250. In some embodiments, transient memory allocation object code is defined in the smart card applet 250 and includes a volatile memory allocation object type keyword. In some embodiments, the volatile memory allocation object type keyword is a keyword in the smart card applet 250 indicative of allocating volatile memory of volatile memory 180 for storage of an object in volatile memory 180. In some embodiments, the volatile memory allocation object type keyword may be a transient memory allocation object type keyword, such as, for example, the keyword “TRANSIENT” utilized in a set allocation type method (e.g., System.setAllocationType (System.TRANSIENT), where setAllocationType is a method configured to set the allocation type defined in the set allocation type method (e.g., a “TRANSIENT” type). In some embodiments, an example of the utilizing the transient memory allocation object type keyword to allocate volatile memory from volatile memory 180 is exemplified in the code below:

```
    public class Example {
          /*** Example of Allocation of Volatile Memory 180 for Object Reference*/
          public transient MyClass objectRef;
          /*** Example of Allocation of Volatile Memory 180 for Object
          * MyClass( ) - is Allocated in Volatile Memory 180 (e.g., RAM)*/
          public void createInstance( ){
                // System Determines Whether Enough Volatile Memory of Volatile
Memory 180 Is Available
    // Cursor Type for Memory Allocation
                System.setAllocationType(System.TRANSIENT);
                objectRef = new MyClass( );
                System.setAllocationType(System.DEFAULT);
          }
    }
```

In some embodiments, in the volatile memory allocation object example above, the executable code in smart card applet 250 defines an object (e.g., MyClass) as being allocated to volatile memory of volatile memory 180. In some embodiments, the smart card applet 250 utilizes a set allocation type (e.g., setAllocationType) with the transient memory allocation object type keyword “TRANSIENT” to indicate to the smart card applet assessment and allocation unit 242 during runtime to allocate volatile memory of volatile memory 180 to the object defined utilizing “new” in the object-oriented programming language (e.g., objectRef=new MyClass( );). In some embodiments, setAllocationType is a method or predefined code, such as, for example, a cursor, configured to allocate the object utilizing the transient memory allocation object type keyword (e.g., TRANSIENT). In some embodiments, during runtime of the smart card applet 250 by smart card applet installation unit 220, the smart card applet assessment and allocation unit 241 allocates volatile memory of volatile memory 180 for the object as defined utilizing the transient memory allocation object type keyword. In some embodiments, the DEFAULT keyword is utilized by the set allocation type (e.g., System.setAllocationType (System.DEFAULT)) in the smart card applet 250 to stop the allocation of volatile memory 180 for additional objects not defined utilizing the transient memory allocation object type keyword (System.setAllocationType (System.TRANSIENT)) and utilize a default memory allocation mode defined in the smart card applet 250 and/or smart card 100 (e.g., a non-volatile memory allocation mode). In some embodiments, the allocation of the volatile memory 180 for an object reference and the object is described further herein with reference to FIG. 3 and FIG. 4, respectively.

FIG. 3 is a flow diagram illustrating an object reference volatile memory allocation method 300 in accordance with some embodiments. In some embodiments, the object reference volatile memory allocation method 300 is utilized by the smart card applet assessment unit and allocation unit 241 of object entity volatile memory allocation system 170 to allocate volatile memory of volatile memory 180 for an object reference defined in the smart card applet 250 utilizing a transient memory allocation object reference type keyword. In some embodiments, the method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the object reference volatile memory allocation method 300 is described with reference to the figures described herein.

In some embodiments, at operation 310, smart card applet assessment and allocation unit 241 of smart card applet installation unit 220 receives smart card applet 250 from, for example, an external entity, such as, for example, a card issuer or card management system, and commences the process of installing the smart card applet 250 onto non-volatile memory 140. In some embodiments, as stated previously, smart card applet 250 is an object-oriented programming smart card applet that, in addition to being configured to execute on smart card 100, is configured to define transient memory allocation object entity code utilized by the object entity volatile memory allocation system 170 to allocate volatile memory of volatile memory 180. In some embodiments, after receiving the smart card applet 250, operation 310 proceeds to operation 320.

In some embodiments, at operation 320, during the installation process of the smart card applet 250, smart card applet assessment and allocation unit 241 assesses the smart card applet 250 to determine whether an object reference in smart card applet 250 has been designated for allocation of volatile memory in volatile memory 180 (e.g., by performing the transient memory allocation object reference code assessment of smart card applet 250). In some embodiments, smart card applet assessment and allocation unit 241 performs the transient memory allocation object reference code assessment by performing an assessment of the smart card applet 250 for transient memory allocation object reference code indicative of allocating volatile memory of volatile memory 180 for the object reference defined in the smart card applet 250. In some embodiments, as stated previously, the transient memory allocation object reference code includes a volatile memory object reference allocation type keyword that may be a transient memory allocation object reference type keyword, such as, for example, the keyword “transient” associated with the object reference. In some embodiments, for the example given with reference to FIG. 2, for a smart card 100 (e.g., a Java Card utilizing Java object-oriented programming language), volatile memory of volatile memory 180 may be allocated using the transient memory allocation object reference type keyword transient in the following Java code, “public transient MyClass objectRef”, as described previously herein with reference to FIG. 2. In some embodiments, as part of the transient memory allocation object reference code assessment, the smart card applet assessment and allocation unit 241 examines the bytecode of the smart card applet 250 and inspects the class hierarchy, static fields, constant pool, and methods in the smart card applet 250. In some embodiments, during the transient memory allocation object reference code assessment, when the smart card applet assessment and allocation unit 241 identifies the object reference and determines (using the transient memory allocation object reference type keyword) that the object reference requires volatile memory allocation from volatile memory 180, operation 320 proceeds to operation 330.

In some embodiments, at operation 330, when an object reference is identified as a transient memory allocation object reference type, smart card applet assessment and allocation unit 241 allocates volatile memory of volatile memory 180 for the object reference. In some embodiments, the object reference volatile memory allocation involves reserving a specific portion of volatile memory 180 dedicated to the object reference (e.g., objectRef) and its associated data. In some embodiments, by allocating memory during the installation process, the smart card applet assessment and allocation unit 241 ensures that the object reference has a predetermined volatile memory space available for efficient access and management during the execution of the smart card applet 250 on the smart card 100. In some embodiments, the embodiments described herein improve upon existing memory allocation systems and techniques by optimizing the utilization of volatile memory 180 during the installation of the smart card applet 250 and facilitating the proper functioning of the smart card applet 250 with regards to the identified object references. For example, in some embodiments, utilizing the embodiments described herein improves upon other memory allocation systems by allowing for the updating of a dynamic variable without stressing memory, allowing fast memory access when retrieving data, and saving stack space without having to pass an object reference in an argument of a method during a call of the method, whilst, for example, keeping the application design in proper object oriented design methodologies.

FIG. 4 is a flow diagram illustrating an object volatile memory allocation method 400 in accordance with some embodiments. In some embodiments, the object volatile memory allocation method 400 is utilized by the smart card applet assessment unit and allocation unit 242 of object entity volatile memory allocation system 170 to allocate volatile memory of volatile memory 180 for an object defined in the smart card applet 250 utilizing a transient memory allocation object type keyword. In some embodiments, the method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the object volatile memory allocation method 400 is described with reference to the figures described herein.

In some embodiments, at operation 410, smart card applet assessment and allocation unit 241 of smart card applet installation unit 220 receives smart card applet 250 and installs the smart card applet 250 onto non-volatile memory 140. In some embodiments, as stated previously, smart card applet 250 is an object-oriented programming applet that, in addition to being configured to execute on smart card 100, is configured to define transient memory allocation object entity code utilized by the object entity volatile memory allocation system 170 to allocate volatile memory of volatile memory 180. In some embodiments, after receiving and installing the smart card applet 250, operation 410 proceeds to operation 420.

In some embodiments, at operation 420, SCVM 230 interprets and executes the code in the smart card applet 250 during runtime in a smart card runtime environment of the smart card 100. In some embodiments, the smart card runtime environment, may be, for example, a Java card runtime environment where the methods in the smart card applet 250 may be invoked in response to various events or commands. In some embodiments, the execution of the smart card applet 250 typically follows a specific lifecycle, which includes the selection and initialization of the smart card applet 250, the processing of commands, and the termination or deselection of the smart card applet 250. In some embodiments, the smart card runtime environment manages the execution of the smart card applet 250, performs some of the embodiments described herein, which includes, for example, executing some of the methods described herein (e.g., object volatile memory allocation method 400), and provides security and integrity features described further herein. In some embodiments, during execution of the smart card applet 250, operation 420 proceeds to operation 430.

In some embodiments, at operation 430, during the execution of the smart card applet 250 at runtime, smart card applet assessment and allocation unit 242 performs the transient memory allocation object code assessment of smart card applet 250. In some embodiments, smart card applet assessment and allocation unit 242 performs the transient memory allocation object code assessment by performing an assessment of the smart card applet 250 for a transient memory allocation object type keyword indicative of allocating volatile memory of volatile memory 180 for the object defined in the smart card applet 250. In some embodiments, as stated previously, the volatile memory object allocation type keyword may be a transient memory allocation object type keyword, such as, for example, the keyword “TRANSIENT” utilized in a set allocation type method (e.g., System.setAllocationType (System.TRANSIENT), where setAllocationType is a cursor or cursor-like method configured to set the allocation type the type defined in the method (e.g., a “TRANSIENT” type). In some embodiments, a cursor-like method is a method that utilizes a transient memory allocation object type keyword and has both a start point of volatile memory allocation for an object (e.g., a start object volatile memory allocation point) and a stop point of volatile memory allocation for an object (e.g., a stop object volatile memory allocation point). For example, System.setAllocationType (System.TRANSIENT) may be a start point that indicates that the object or objects defined before the stop point but after the System.setAllocationType (System.TRANSIENT) should be allocated volatile memory in volatile memory 180. In some embodiments, System.setAllocationType (System.DEFAULT) may be a stop point that indicates that the allocation volatile memory of volatile memory 180 indicated by System.setAllocationType (System.TRANSIENT) should cease after System.setAllocationType (System.DEFAULT).

In some embodiments, during the transient memory allocation object code assessment, the smart card applet assessment and allocation unit 242 examines the bytecode instructions, class relationships, static fields, constant pool entries, and method invocations to identify objects intended for volatile memory allocation in volatile memory 180. In some embodiments, during the transient memory allocation object reference assessment, when the smart card applet assessment and allocation unit 242 identifies an object and determines, using the transient memory allocation object type keyword, that the object requires volatile memory allocation from volatile memory 180, operation 430 proceeds to operation 440.

In some embodiments, at operation 440, when the transient memory allocation object code assessment indicates that the object should be allocated to volatile memory of volatile memory 180, the smart card applet assessment and allocation unit 242 allocates and reserves the volatile memory within the volatile memory 180. In some embodiments, the allocation of volatile memory of volatile memory 180 for the object involves reserving a specific portion of volatile memory 180 dedicated to the object and its associated data. In some embodiments, the smart card applet assessment and allocation unit 242 of SCVM 230 may be configured to dynamically allocate volatile memory from an object heap in volatile memory 180 to create and manage the objects allocated volatile memory. In some embodiments, volatile memory from volatile memory 180 is allocated for object instantiation, method invocations, and other runtime operations. In some embodiments, by allocating memory during runtime utilizing the embodiments described herein, the smart card applet assessment and allocation unit 241 ensures that the object and its associated data have a predetermined volatile memory space available for efficient access and management during runtime and the execution of the smart card applet 250 on the smart card 100. Further, the volatile memory allocation for objects utilizing the embodiments described herein ensures that the objects can be efficiently accessed and modified during runtime and the execution of the smart card applet 250. In some embodiments, by selectively allocating objects to volatile memory, the smart card applet assessment and allocation unit 242 optimizes memory utilization and enhances the performance of the smart card 100, allowing for effective management and execution of smart card applets in resource-constrained environments.

In some embodiments, smart card 100 may include a security and integrity unit. In some embodiments, the security and integrity unit may be executable code configured to perform encryption and checksum operations for the embodiments described herein. In some embodiments, cryptographic module 150 may be configured to perform the operations of the security and integrity unit. In some embodiments, for example, with reference to the example in FIG. 2, when, at runtime, volatile memory of volatile memory 180 is allocated for the object and an object is created (e.g., using “objectRef=new MyClass( )”), security and integrity unit may perform encryption operations and checksum operations on the newly created object (e.g., MyClass( )).

In some embodiments, for checksum operations, when the object is created or modified, a checksum algorithm is applied to the object's data. In some embodiments, the security and integrity unit generates a checksum value based on the content of the object and utilizes the checksum to verify the integrity of the object. In some embodiments, for encryption operations, when the object is encrypted by the security and integrity unit, the object's data is processed using an encryption algorithm along with an encryption key. In some embodiments, the encryption algorithm ascertains the data associated with the object and transforms the data associated with the object into ciphertext, which is an encrypted representation of the object data. In some embodiments, the encryption key may be utilized by the security and integrity unit to control the encryption process and for decryption of the object.

In some embodiments, in order to read data associated with the objects and object references written to the volatile memory allocated by the object entity volatile memory allocation system 170, the SCVM 230 determines the type of memory the data is stored in (e.g., volatile memory or non-volatile memory), and if the memory type is a transient memory type (e.g., volatile memory), the SCVM 230 then verifies the checksum. In some embodiments, when the checksum is verified, the smart card applet 250 utilizes the read data for the prescribed actions in the smart card applet 250. In some embodiments, when the data associated with objects and object references stored in volatile memory 180 have been encrypted by the security and integrity unit, the data is decrypted before processing the data.

In some embodiments, in order to release the volatile memory that has been allocated by the object entity volatile memory allocation system 170, when the object or object reference usage is finished, the object or object refence is set to null, then the allocated volatile memory is released from volatile memory 180 into a free pool of volatile memory (e.g., volatile memory that may be allocated for new objects or object references).

In some embodiments, the object entity volatile memory allocation system may be configured to update or write an object entity to volatile memory for an object reference or object during runtime of the smart card applet.

In some embodiments, a computer-implemented method includes receiving a smart card applet for program execution on a smart card; determining whether a memory allocation type keyword provided via the smart card applet is of a transient memory allocation type; and when the memory allocation type keyword is of the transient memory allocation type, allocating volatile memory from the smart card for temporary storage of an object entity.

In some embodiments, the computer-implemented method further includes using a transient allocation type keyword to indicate whether the memory allocation type keyword is the transient memory allocation type.

In some embodiments of the computer-implemented method, the object entity is either an object or an object reference.

In some embodiments of the computer-implemented method, a start cursor and an end cursor are utilized during allocation of the volatile memory for the object.

In some embodiments of the computer-implemented method, the start cursor is utilized in a smart card runtime environment during the allocation of the volatile memory.

In some embodiments of the computer-implemented method, the volatile memory allocated for the object is utilized for a new object instance of the object.

In some embodiments of the computer-implemented method, the end cursor is utilized to stop allocation of volatile memory for the object.

In some embodiments of the computer-implemented method, transient is the transient allocation type keyword.

In some embodiments, a computer-implemented method includes receiving a smart card applet at a smart card that defines a memory allocation type keyword for allocation of memory for an object reference; determining whether the memory allocation type keyword provided via the smart card applet is a transient memory allocation type; and when the memory allocation type keyword is the transient memory allocation type, allocating volatile memory from the smart card for temporary storage of the object reference.

In some embodiments, a computer-implemented method includes using a transient allocation type keyword to indicate whether the memory allocation type keyword is the transient memory allocation type.

In some embodiments of the computer-implemented method further includes, writing data into the volatile memory allocated for the object reference.

In some embodiments of the computer-implemented method, the volatile memory is allocated during an installation of the smart card applet.

In some embodiments of the computer-implemented method, the volatile memory allocated during the installation of the smart card applet is random-access memory.

In some embodiments of the computer-implemented method, when there is a context switch from the smart card applet after the object reference has been stored in the volatile memory, the object reference stored in the volatile memory remains in the volatile memory in order to retrieve the object reference after context switching back to the smart card applet.

In some embodiments of the computer-implemented method, the memory allocation type keyword provided via the smart card applet is a transient memory allocation type whose type is determined during installation of the smart card applet onto the smart card.

In some embodiments of the computer-implemented method, when the memory allocation type keyword is not the transient memory allocation type, allocating non-volatile memory from the smart card for storage of the object reference.

In some embodiments, an object entity volatile memory allocation system includes an object reference smart card applet assessment and allocation unit; and an object smart card applet assessment and allocation unit, wherein the object entity volatile memory allocation system utilizes the object reference smart card applet assessment and allocation unit to allocate volatile memory for an object reference during installation of a smart card applet and the object entity volatile memory allocation system utilizes the object smart card applet assessment and allocation unit to allocate the volatile memory for an object during runtime of the smart card applet.

In some embodiments of the object entity volatile memory allocation system, a transient allocation object reference type keyword is utilized to allocate volatile memory for the object reference during an installation of a smart card applet.

In some embodiments of the object entity volatile memory allocation system, a transient allocation object type keyword is utilized to allocate the volatile memory for an object during execution of the smart card applet at a runtime of the smart card applet.

In some embodiments of the object entity volatile memory allocation system, in order to determine whether a keyword in the smart card applet is a transient allocation object reference type keyword or a transient allocation object type keyword, the object entity volatile memory allocation system performs a transient memory allocation object reference code assessment of the smart card applet and a transient memory allocation object code assessment of the smart card applet.

What is claimed is:

1. A computer-implemented method, comprising:
receiving a smart card applet for program execution on a smart card;
determining whether a memory allocation type keyword provided via the smart card applet is of a transient memory allocation type; and
when the memory allocation type keyword is of the transient memory allocation type, allocating volatile memory from the smart card for temporary storage of an object entity.

2. The computer-implemented method of claim 1, further comprising:
using a transient allocation type keyword to indicate whether the memory allocation type keyword is the transient memory allocation type.

3. The computer-implemented method of claim 2, wherein:
the object entity is either an object or an object reference.

4. The computer-implemented method of claim 3, wherein:
a start cursor and an end cursor are utilized during allocation of the volatile memory for the object.

5. The computer-implemented method of claim 4, wherein:
the start cursor is utilized in a smart card runtime environment during the allocation of the volatile memory.

6. The computer-implemented method of claim 5, wherein:
the volatile memory allocated for the object is utilized for a new object instance of the object.

7. The computer-implemented method of claim 6, wherein:
the end cursor is utilized to stop allocation of volatile memory for the object.

8. The computer-implemented method of claim 7, wherein:
transient is the transient allocation type keyword.

9. A computer-implemented method, comprising:
receiving a smart card applet at a smart card that defines a memory allocation type keyword for allocation of memory for an object reference;
determining whether the memory allocation type keyword provided via the smart card applet is a transient memory allocation type; and
when the memory allocation type keyword is the transient memory allocation type, allocating volatile memory from the smart card for temporary storage of the object reference.

10. The computer-implemented method of claim 9, further comprising:
using a transient allocation type keyword to indicate whether the memory allocation type keyword is the transient memory allocation type.

11. The computer-implemented method of claim 10, further comprising:
writing data into the volatile memory allocated for the object reference.

12. The computer-implemented method of claim 11, wherein:
the volatile memory is allocated during an installation of the smart card applet.

13. The computer-implemented method of claim 12, wherein:
the volatile memory allocated during the installation of the smart card applet is random-access memory.

14. The computer-implemented method of claim 13, wherein:
when there is a context switch from the smart card applet after the object reference has been stored in the volatile memory, the object reference stored in the volatile memory remains in the volatile memory in order to retrieve the object reference after context switching back to the smart card applet.

15. The computer-implemented method of claim 14, wherein:
the memory allocation type keyword provided via the smart card applet is a transient memory allocation type whose type is determined during installation of the smart card applet onto the smart card.

16. The computer-implemented method of claim 15, wherein:
when the memory allocation type keyword is not the transient memory allocation type, allocating non-volatile memory from the smart card for storage of the object reference.

17. An object entity volatile memory allocation system, comprising:
an object reference smart card applet assessment and allocation unit; and
an object smart card applet assessment and allocation unit, wherein the object entity volatile memory allocation system utilizes the object reference smart card applet assessment and allocation unit to allocate volatile memory for an object reference during installation of a smart card applet and the object entity volatile memory allocation system utilizes the object smart card applet assessment and allocation unit to allocate the volatile memory for an object during runtime of the smart card applet.

18. The object entity volatile memory allocation system of claim 17, wherein:
a transient allocation object reference type keyword is utilized to allocate volatile memory for the object reference during an installation of a smart card applet.

19. The object entity volatile memory allocation system of claim 18, wherein:
a transient allocation object type keyword is utilized to allocate the volatile memory for an object during execution of the smart card applet at a runtime of the smart card applet.

20. The object entity volatile memory allocation system of claim 19, wherein:
in order to determine whether a keyword in the smart card applet is a transient allocation object reference type keyword or a transient allocation object type keyword, the object entity volatile memory allocation system performs a transient memory allocation object reference code assessment of the smart card applet and a transient memory allocation object code assessment of the smart card applet.
